(19) United States
(12) Patent Application Publication
(10) Pub. No.: US 2025/0128413 A1
(43) Pub. Date: Apr. 24, 2025

(54) ROBOT OPERATION DETERMINATION DEVICE, OPERATION DETERMINATION METHOD, AND OPERATION DETERMINATION PROGRAM

(71) Applicant: FANUC CORPORATION, Minamitsuru-gun, Yamanashi (JP)

(72) Inventor: Daiki HAYASHI, Yamanashi (JP)

(73) Assignee: FANUC CORPORATION, Minamitsuru-gun, Yamanashi (JP)

(21) Appl. No.: 18/701,522

(22) PCT Filed: Oct. 25, 2021
(86) PCT No.: PCT/JP2021/039252

§ 371 Date: Apr. 15, 2024

(51) Int. Cl. B25J 9/16

(52) U.S. Cl. CPC B25J 9/1664

(57) ABSTRACT

This robot operation determination device includes: an input unit for inputting position information of at least two teaching points of an operation program for operating a robot; a storage unit that stores an allowable movement amount; a calculation unit that calculates a movement amount between adjacent teaching points in the operation program on the basis of the position information input into the input unit; a determination unit that determines whether the movement amount calculated by the calculation unit is larger than the allowable movement amount stored in the storage unit; and a display unit that, when the determination unit determines that the movement amount is larger than the allowable movement amount, performs a display to that effect.

### RELATED APPLICATION DATA

### Technical Field

The present disclosure relates to a robot operation determination device, an operation determination method, and an operation determination program.

### BACKGROUND ART

A known robot controller in the related art sets an allowable range for a teaching position that is likely to be changed, among teaching positions set in an operation program (for example, see PTL 1). When the teaching position that is likely to be changed is changed, this controller determines whether the changed teaching position is located within the allowable range.

Furthermore, a simulation program for checking whether teaching positions set in an operation program of a robot are actually reachable or whether a robot passes through a singular point during operation is generally known.

### CITATION LIST

### Patent Literature

{PTL 1} Japanese Unexamined Patent Application, Publication No. 2020-37165

### SUMMARY OF INVENTION

An aspect of the present disclosure is a robot operation determination device including: an input unit through which position information of at least two teaching points in an operation program for operating a robot is entered; a storage unit that stores an allowable traveling amount; a calculation unit that calculates a traveling amount between adjacent teaching points in the operation program on a basis of the position information entered through the input unit; a determination unit that determines whether the traveling amount calculated by the calculation unit is larger than the allowable traveling amount stored in the storage unit; and a display that displays a determination when the determination unit has determined that the traveling amount is larger than the allowable traveling amount.

### BRIEF DESCRIPTION OF DRAWINGS

FIG. 1 is a block diagram illustrating a robot operation determination device according to an embodiment of the present disclosure.

FIG. 2 shows an example screen displayed on a monitor of the operation determination device in FIG. 1.

FIG. 3 is a flowchart illustrating a robot operation determination method according to the embodiment of the present disclosure.

FIG. 4 is a flowchart describing a setting step in the operation determination method in FIG. 3.

FIG. 5 is a flowchart describing a first determination step in the operation determination method in FIG. 3.

FIG. 6 is a flowchart describing a second determination step in the operation determination method in FIG. 3.

### DESCRIPTION OF EMBODIMENTS

A robot operation determination device 1 and an operation determination method according to an embodiment of the present disclosure will be described below with reference to the drawings.

The robot operation determination device 1 according to this embodiment is a robot simulation device and includes a computer including at least one processor and at least one memory.

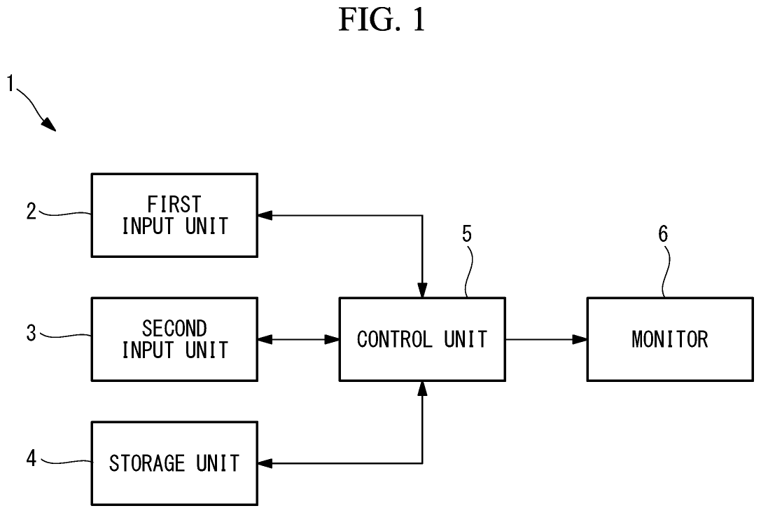

As illustrated in FIG. 1, the operation determination device 1 includes a first input unit (input unit) 2, a second input unit 3, a storage unit 4, a control unit (calculation unit, determination unit) 5, and a monitor 6.

The first input unit 2 is any input device, such as a touch panel, a keyboard, or a mouse.

The second input unit 3 is a connector connected to a robot controller or a computer-aided design (CAD) device for creating an operation program, or a reading device for reading an operation program stored in a computer-readable storage medium, such as a compact disc (CD) or a digital versatile disc (DVD).

The control unit 5 displays various information on the monitor 6, reads information out of the storage unit 4, and performs various calculations and determinations on the basis of the information entered through the first input unit 2 and the second input unit 3.

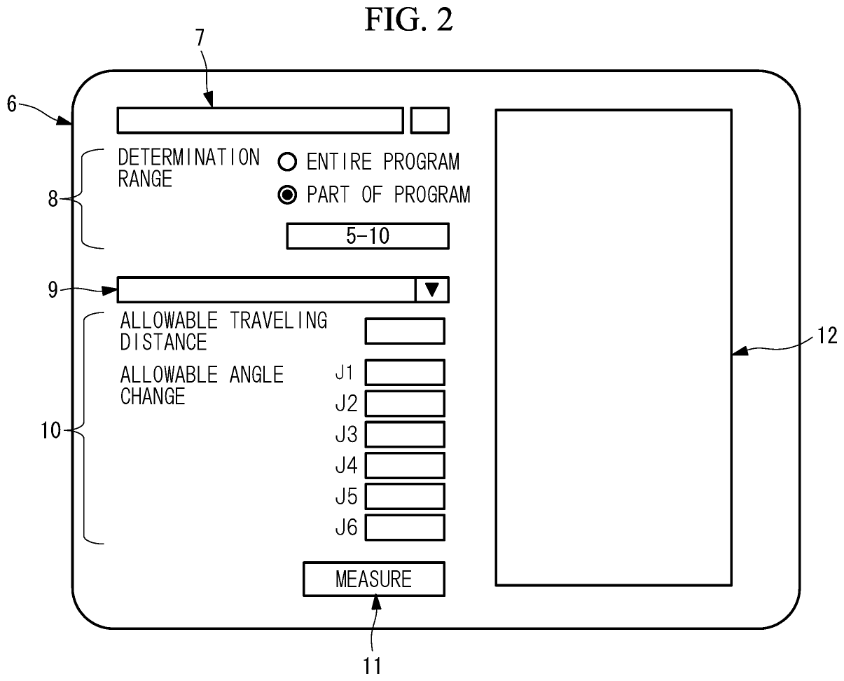

As illustrated in FIG. 2, the monitor 6 includes a first display area 7 used to select the operation program, a second display area 8 used to designate the area of determination in the operation program, and a third display area 9 used to select the robot model. The monitor 6 further includes a fourth display area 10 used to input an allowable traveling amount, a fifth display area 11 displaying a start button for starting determination, and a sixth display area (display) 12 for displaying the result of the determination if a defect has been found in the operation program.

FIG. 2 shows an example screen displayed on the monitor 6, so that items to be input, the method of input, and the layout may be selected as desired.

The storage unit 4 stores specifications of robots in association with robot model names. The specifications of robots include: the dimensions of mechanical units of the robots; the operable angular ranges of axes J1, J2, J3, J4, J5, and J6 of the robots; the position information of singular points, which are the positions the robot should avoid moving to; and the allowable angular velocities of the axes J1, J2, J3, J4, J5, and J6.

An operator enters an allowable traveling amount to the fourth display area 10 of the monitor 6, using the first input unit 2. The allowable traveling amount entered by using the first input unit 2 includes an allowable traveling distance, which is the allowable value of the distances between two adjacent teaching points in the operation program, and allowable angle changes, which are the allowable values of the changes in the angles of the axes J1, J2, J3, J4, J5, and J6 between two adjacent teaching points. The entered allowable traveling amount is stored in the storage unit 4.

The operator also enters the robot model name in the third display area 9 of the monitor 6, using the first input unit 2. For example, the operator can select, using the first input unit 2, the appropriate model name from candidates of robot model names indicated in the form of a pull-down menu in the third display area 9 of the monitor 6.

When the operator selects a robot model name displayed in the third display area 9 using the first input unit 2, the specifications of the robot stored in the storage unit 4 in association with the selected model name are read out. The read-out specifications of the robot will be used in the control unit 5.

The operating program typically includes multiple program lines. Each program line in the operation program describes the position information of a teaching point, an operation command to move to the teaching point, an operation speed, and the like. The operation command includes a P-to-P operation, a linear interpolation operation, a circular interpolation operation, or the like.

The position information of a teaching point is defined by the position of a tool center point (TCP) defined at a desired position of a tool attached to a distal-end flange of the robot, and the orientation of a tool coordinate system fixed to the TCP with respect to a reference coordinate system of the robot.

Hence, the TCP is defined in the operation program.

The control unit 5 calculates, on the basis of the operation program entered through the second input unit 3 and the specifications of the robot read out from the storage unit 4, the angles of the axes J1, J2, J3, J4, J5, and J6 of the robot when the TCP is positioned at the respective teaching points.

The control unit 5 also calculates, from the angles of the axes J1, J2, J3, J4, J5, and J6 calculated for the respective teaching points and the operation speed, the angular velocities of the axes J1, J2, J3, J4, J5, and J6 when the robot moves toward the respective teaching points.

The control unit 5 also calculates, from the position information of the respective teaching points, a path of the TCP when the operation program is executed.

Furthermore, the control unit 5 determines whether the calculated angles are within the motion ranges of the axes J1, J2, J3, J4, J5, and J6, whether the angular velocities are higher than the allowable angular velocities, and whether the path of the TCP passes through the vicinity of a singular point.

If, in any of the axes J1, J2, J3, J4, J5, and J6, the angle is outside the motion range or the angular velocity is higher than the allowable angular velocity, or if the path of the TCP passes through the vicinity of a singular point, the control unit 5 displays that fact on the sixth display area 12 of the monitor 6. The display at this time include the program line number including the teaching point that causes the angle to be outside the motion range, the teaching point that causes the angular velocity to exceed the allowable angular velocity, or the teaching point that causes the TCP to pass through the vicinity of a singular point.

Furthermore, in this embodiment, the control unit 5 calculates the distances and the changes in the angles of the axes J1, J2, J3, J4, J5, and J6 between two adjacent teaching points in the operation program, on the basis of the operation program entered through the second input unit 3. The distances between the teaching points can be directly calculated from the coordinate values of the TCP described as the teaching points. Furthermore, the changes in the angles of the axes J1, J2, J3, J4, J5, and J6 can be calculated from the differences in angle between two teaching points by using the angles of the axes J1, J2, J3, J4, J5, and J6 at the respective teaching points calculated on the basis of the position information of the respective teaching points.

Then, the control unit 5 determines whether the calculated distances between two teaching points are larger than the allowable traveling distance, and whether the calculated changes in the angles of the axes J1, J2, J3, J4, J5, and J6 between two teaching points are larger than the allowable angle changes.

If the distances are larger than the allowable traveling distance, or if the angle changes are larger than the allowable angle changes, the control unit 5 displays the fact on the sixth display area 12. At this time, the program line numbers including the teaching points that appear later in the operation program are also displayed.

A robot operation determination method according to this embodiment will be described below with reference to the drawings.

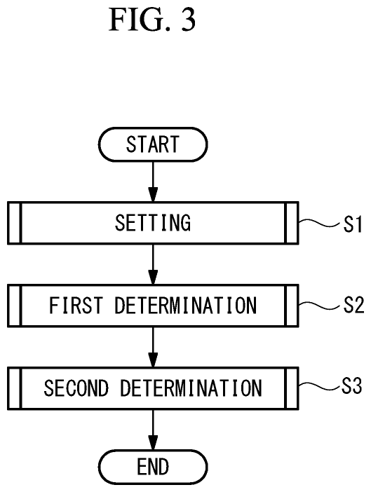

As illustrated in FIG. 3, the operation determination method according to this embodiment includes a setting step S1, a first determination step S2, and a second determination step S3.

In the setting step S1, as illustrated in FIG. 2, first, the control unit 5 displays the screen illustrated in FIG. 2 on the monitor 6.

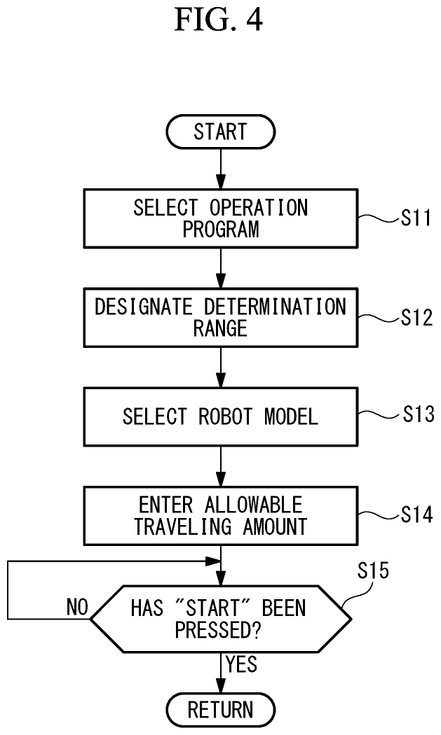

As illustrated in FIG. 4, the operator selects, using the first input unit 2, the operation program to be subjected to determination from among the operation programs displayed on the first display area 7 of the monitor 6 (step S11). When the operation program is selected, the selected operation program is read from the second input unit 3 and stored in the storage unit 4.

Next, the operator designates, using the first input unit 2, the determination range to be subjected to determination in the operation program, in the second display area 8 of the monitor 6 (step S12). The designation of the determination range is performed by selecting whether to perform the determination on the entire operation program or on a part of the operation program, and, when the determination is to be performed on a part of the operation program, the designation is performed by using, for example, program line numbers of the operation program.

Next, the operator selects the robot model to be subjected to the determination in the third display area 9 of the monitor 6 (step S13). The operator selects the appropriate model from the robot model candidates displayed in the third display area 9 of the monitor 6, using the first input unit 2.

Next, the operator enters the allowable traveling amount of the robot in the fourth display area 10 of the monitor 6 (step S14). As the allowable traveling amount, the allowable traveling distance and the allowable angle changes between any two adjacent points in the operation program are entered. In the example illustrated in FIG. 2, a single value may be entered as the allowable traveling distance, and individual values for the axes J1, J2, J3, J4, J5, and J6 may be entered as the allowable angle changes.

Once these items have been entered, it is determined whether the operator has pressed the start button displayed in the fifth display area 11 (step S15). When the start button is pressed in step S15, the process proceeds to the first determination step S2.

Next, the first determination step S2 will be described.

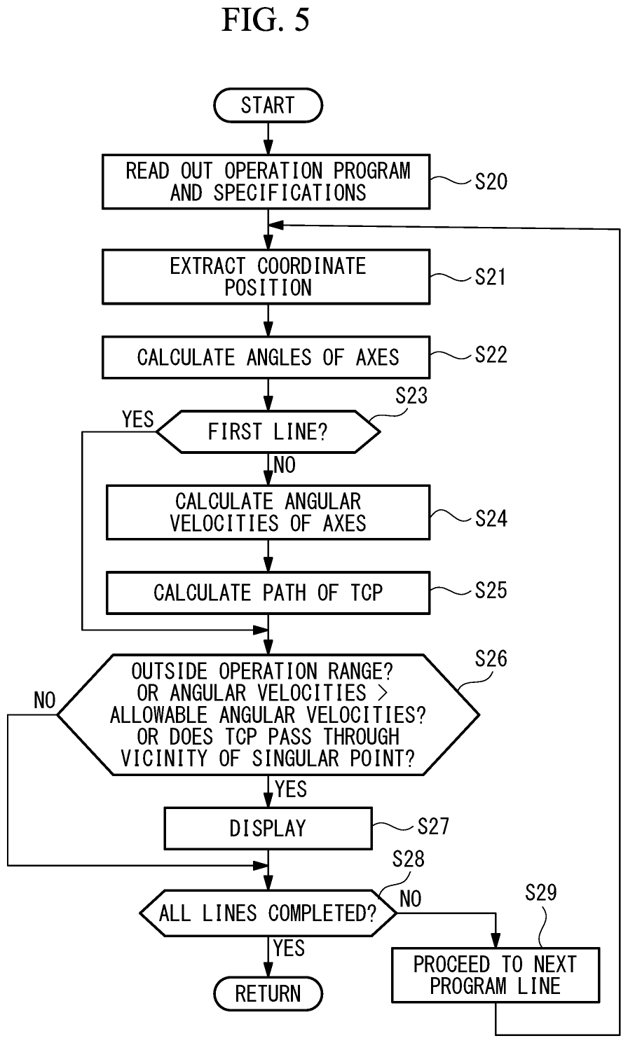

First, as illustrated in FIG. 5, the control unit 5 reads out the operation program and the specifications of the robot stored in the storage unit 4 on the basis of the operation program selected in step S11 and the robot model selected in step S13 (step S20). The control unit 5 sequentially processes the read-out operation program from the first program line, or from the first program line in the determination range when the determination range is designated in step S12.

The control unit 5 extracts the position coordinates (position information) of the teaching point included in the program line being processed (step S21). The extracted position coordinates are stored in the storage unit 4 in association with the program line number.

Then, the control unit 5 calculates the angles of the axes J1, J2, J3, J4, J5, and J6 of the robot when the TCP is positioned at the teaching point, on the basis of the extracted position coordinates and the specifications of the robot (step S22). The calculated angles are also stored in the storage unit 4 in association with the program line number.

At this time, the control unit 5 determines whether the program line being processed is the first program line (step S23), and if it is the first program line, the control unit 5 executes the processing from step S26. If the program line being processed is not the first program line, the following processing is performed.

Specifically, from the angles of the axes J1, J2, J3, J4, J5, and J6 calculated for the teaching point in the program line being processed and for the teaching point in the previous program line and the operation speed in the operation program, the angular velocities of the axes J1, J2, J3, J4, J5, and J6 when moving toward the teaching point are calculated (step S24). Furthermore, from the position information of the aforementioned two teaching points, the path of the TCP from the teaching point in the previous program line to the teaching point in the program line being processed is calculated (step S25).

Then, it is determined whether the angles of the axes J1, J2, J3, J4, J5, and J6 are outside their motion ranges, whether the angular velocities of the axes J1, J2, J3, J4, J5, and J6 are larger than their allowable angular velocities, or whether the path of the TCP passes through the vicinity of a singular point (step S26). If the angle of any of the axes J1, J2, J3, J4, J5, and J6 is outside the motion range at the teaching point in the program line being processed, that fact and the program line number are sent to and displayed on the monitor 6 (step S27).

If the angular velocity of any of the axes J1, J2, J3, J4, J5, and J6 moving toward the teaching point in the program line being processed is larger than the allowable angular velocity, that fact and the program line number are sent to and displayed on the monitor 6 (step S27).

Furthermore, if the TCP passes through the vicinity of a singular point in the path to the teaching point in the program line being processed, that fact and the program line number are sent to and displayed on the monitor 6 (step S27).

In step S27, the fact that the transmitted teaching point has a defect and the program line number are displayed on the sixth display area 12 of the monitor 6.

Then, it is determined whether all the program lines, or the last program line in the determination range when the determination range is designated, have been processed (step S28). If the processing has not been completed up to the last program line, the process proceeds to the next program line (step S29), and the process from step S21 is repeated. In step S28, if the processing has been completed up to the last program line, the process proceeds to the second determination step S3.

Next, the second determination step S3 will be described.

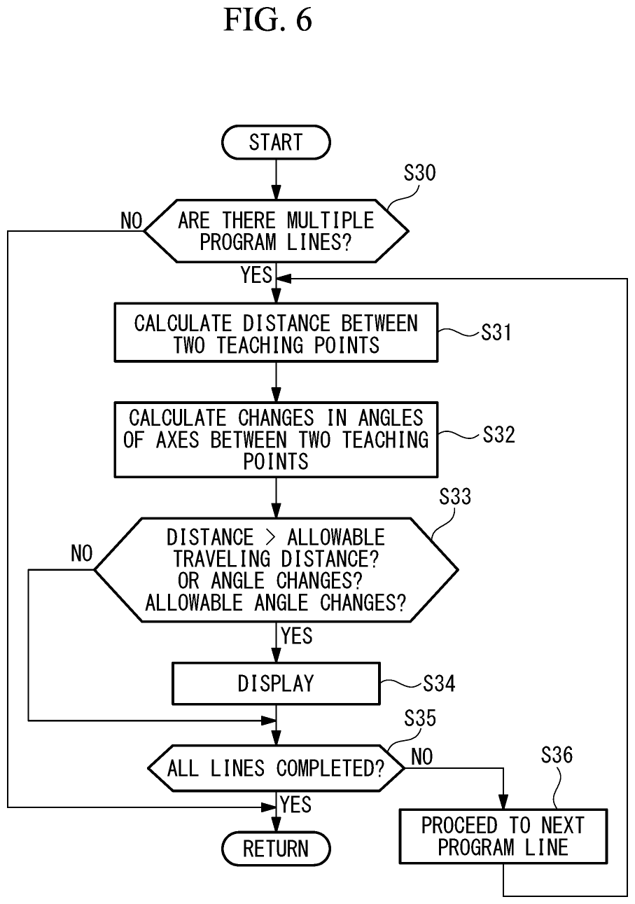

As illustrated in FIG. 6, the control unit 5 determines whether there are multiple program lines in the operation program read out in step S20, or whether there are multiple program lines in the determination range when the determination range is designated in step S12 (step S30). If there is a single program line, the processing is terminated.

In step S30, if there are multiple program lines, the processing is performed sequentially from the second program line from the first in the operation program, or from the second program line from the first in the determination range when the determination range is designated in step S12.

The control unit 5 first calculates the distance between two teaching points, namely, the teaching point in the program line to be processed and the teaching point in the previous program line (step S31). The control unit 5 also calculates changes in the angles of the axes J1, J2, J3, J4, J5, and J6 between two teaching points, namely, the teaching point in the program line to be processed and the teaching point in the previous program line (step S32).

The distance can be obtained by directly calculating the direct distance between the two teaching points from the position coordinates of the two teaching points extracted in step S21 and stored in the storage unit 4.

Furthermore, the changes in the angles of the axes J1, J2, J3, J4, J5, and J6 can be easily calculated by calculating, for each of the axes J1, J2, J3, J4, J5, and J6, the difference in the angles of the axes J1, J2, J3, J4, J5, and J6 between two teaching points calculated in step S22 and stored in the storage unit 4.

Next, the control unit 5 determines whether the distance calculated in step S31 is larger than the allowable traveling distance, and whether the angle changes calculated in step S32 are larger than the entered allowable angle changes (step S33). If the calculated distance is larger than the allowable traveling distance, or if the calculated angle changes are larger than the allowable angle changes, that fact and the program line number being processed are sent to and displayed on the monitor 6 (step S34). If the calculated distance is less than or equal to the allowable traveling distance, or if the calculated angle changes are less than or equal to the allowable angle changes, the process proceeds to step S35 described below.

In step S34, the fact that the teaching point has a defect and the program line number are displayed on the sixth display area 12 of the monitor 6.

Then, it is determined whether all the program lines, or the last program line in the determination range when the determination range is designated, have been processed (step S35). If the processing has not been completed up to the last program line, the process proceeds to the next program line (step S36), and the process from step S31 is repeated. In step S35, if the processing has been completed up to the last program line, the processing is terminated.

As described above, according to the robot operation determination device 1 and the operation determination method according to this embodiment, if the distance between two teaching points is larger than the allowable traveling distance or if the changes in the angles of the axes J1, J2, J3, J4, J5, and J6 between two teaching points are larger than the allowable angle changes, that fact is displayed. The distance between two teaching points can be directly obtained from the position coordinates of the two teaching points, and the changes in the angles of the axes J1, J2, J3, J4, J5, and J6 between two teaching points can also be easily obtained from the differences in the angles of the axes J1, J2, J3, J4, J5, and J6. This provides an advantage in that it is possible to easily and quickly check for any teaching position that causes abrupt movements of the robot.

For example, when an operation program for moving a robot at a high speed among multiple teaching points arranged at short distances includes a teaching point that causes the robot to move by a large amount, the robot moves abruptly. According to this embodiment, the presence and absence of such a teaching point can be quickly detected.

If it is determined in the first determination step S2 that the teaching points are within the motion ranges, that the path of the TCP does not pass through the vicinity of a singular point, and that the angular velocities of the axes J1, J2, J3, J4, J5, and J6 are smaller than the allowable angular velocities, the robot can operate. Even in such a case, according to this embodiment, a teaching point that causes abrupt movements of the robot can be easily detected in the second determination step S3.

Furthermore, according to this embodiment, in the first determination step S2, the program line numbers including the teaching point that causes the axes to be outside the motion ranges, the teaching point that causes the TCP to pass through the vicinity of a singular point, and the teaching point that causes the angular velocities of the axes to be higher than the allowable angular velocities are displayed. Furthermore, in the second determination step S3, the program line numbers including the teaching points that are separated by a distance larger than the allowable traveling distance and the teaching points that cause the changes in the angles of the axes J1, J2, J3, J4, J5, and J6 between the teaching points to be larger than the allowable angle changes are displayed. This provides an advantage in that the operator can instantly recognize a defective teaching point and can quickly fix the teaching point.

In this embodiment, it is determined whether both the distances and the changes in the angles of the axes J1, J2, J3, J4, J5, and J6 between two adjacent teaching points in the operation program are larger than the allowable traveling amount. Instead, only one of them may be determined.

Furthermore, the operation determination method in which both the first determination step S2 and the second determination step S3 are performed has been described as an example. Instead, the first determination step S2 and the second determination step S3 may be performed separately. In that case, the steps S20 to S22 in the first determination step S2 may be incorporated into the second determination step S3.

Furthermore, although the robot operation determination device 1 and the operation determination method have been described in this embodiment, the operation determination method described above may be realized as an operation determination program for causing a computer to execute the operation determination method.

In this embodiment, the control unit 5 calculates the traveling distances and the changes in the angles of the axes J1, J2, J3, J4, J5, and J6 between teaching points on the basis of the position coordinates of the teaching points. Furthermore, the control unit 5 determines whether the calculated traveling distances are larger than the allowable traveling distance and whether the calculated angle changes are larger than the allowable angle changes.

Instead, a calculation unit may calculate the traveling distances and/or the angle changes, and a determination unit may perform determination.

Furthermore, although the allowable traveling amount is entered through the first input unit 2, the allowable traveling amount may be stored in the storage unit 4 in advance.

### REFERENCE SIGNS LIST

1 Operation determination device
2 First input unit (input unit)
4 Storage unit
5 Control unit (calculation unit, determination unit)
6 Sixth display area (display)
J1, J2, J3, J4, J5, and J6 Axis

1. A robot operation determination device comprising:
an input unit through which position information of at least two teaching points in an operation program for operating a robot is entered;
a storage unit that stores an allowable traveling amount;
a calculation unit that calculates a traveling amount between adjacent teaching points in the operation program on a basis of the position information entered through the input unit;
a determination unit that determines whether the traveling amount calculated by the calculation unit is larger than the allowable traveling amount stored in the storage unit; and
a display that displays the determination when the determination unit has determined that the traveling amount is larger than the allowable traveling amount.

2. The robot operation determination device according to claim 1, wherein the traveling amount between the teaching points is a distance between the teaching points.

3. The robot operation determination device according to claim 1, wherein the traveling amount between the teaching points is changes in angles of axes of the robot between the teaching points.

4. The robot operation determination device according to claim 1, wherein
the traveling amount between the teaching points is a distance between the teaching points and changes in angles of axes of the robot between the teaching points, and
the display displays the determination when the determination unit has determined that at least one of the distance and the changes in the angles is larger than the allowable traveling amount.

5. The robot operation determination device according to claim 1, wherein
the operation program, which includes program line numbers corresponding to the respective teaching points, is input through the input unit, and
the display displays a program line number corresponding to the position information on a basis of which the traveling amount that is determined to be larger than the allowable traveling amount by the determination unit is calculated.

6. A robot operation determination method comprising:
entering position information of at least two teaching points in an operation program for operating a robot;
calculating a traveling amount between adjacent teaching points in the operation program on a basis of the entered position information;
determining whether the calculated traveling amount is larger than a stored allowable traveling amount; and
displaying a determination when the traveling amount has been determined to be larger than the allowable traveling amount.

7. A non-transitory computer readable medium storing a robot operation determination program for causing a computer to execute a process of:
entering position information of at least two teaching points in an operation program for operating a robot;
calculating a traveling amount between adjacent teaching points in the operation program on a basis of the entered position information;
determining whether the calculated traveling amount is larger than a stored allowable traveling amount; and
displaying the determination when the traveling amount has been determined to be larger than the allowable traveling amount.
